(19) United States
(12) Patent Application Publication
(10) Pub. No.: US 2025/0136054 A1
(43) Pub. Date: May 1, 2025

(54) WIPER BLADE

(71) Applicant: Robert Bosch GmbH, Stuttgart (DE)

(72) Inventors: Marcello Bubba, Linden (BE); Alessandro Riili, Bruxelles (BE); Balazs Czel, Budapest (HU); Peter De Block, Halen (BE); Raf Greunlinx, Zolder (BE); Vojislav Papulanovic, Belgrad (RS)

(21) Appl. No.: 18/908,233

(22) Filed: Oct. 7, 2024

(30) Foreign Application Priority Data
Oct. 27, 2023 (DE) 10 2023 210 684.1

(51) Int. Cl. B60S 1/38; B60S 1/52

(52) U.S. Cl. CPC B60S 1/3805; B60S 1/3848; B60S 1/524

(57) ABSTRACT

A wiper blade (1) for a windshield wiper arrangement (10) includes a base body (2), which extends along a longitudinal direction (25), and a heating element (3), which is designed to heat the wiper blade (1). The base body (2) includes a fastening rail (4) having a fastening groove (5) in which the heating element (3) can be fastened. The fastening groove (5) is open on one side in an opening direction (26) orthogonal to the longitudinal direction (25), and the fastening rail (4) includes fastening arms (41) configured to retain the heating element (3) in the fastening groove (5).

### BACKGROUND

The present invention relates to a wiper blade for a windshield wiper arrangement, and a windshield wiper arrangement.

Windshield wiper arrangements having heaters are known. Such heating apparatuses can, e.g., be used to heat wiper blades and fluid lines that carry windshield washer fluid to washer nozzles in order to prevent the fluid in the lines from freezing. In this context, known apparatuses often feature a complex geometry that takes up a lot of space and are complicated to install and manufacture.

### SUMMARY

In contrast, the wiper blade according to the invention is characterized by a compact, simple, and cost-effective design, which can enable heating of the wiper blade using particularly few components. This is achieved by a wiper blade for a windshield wiper arrangement, in particular for a motor vehicle, comprising a base body which extends along a longitudinal direction and a heating element which is configured to heat the wiper blade. In this case, the base body comprises a fastening rail having a fastening groove. The fastening groove is designed to be open in an opening direction orthogonal to the longitudinal direction. The heating element can be fastened in the fastening groove. The fastening rail comprises fastening arms, which are designed to retain the heating element in the fastening groove, particularly along the opening direction.

Preferably, the heating element is an electric heating element, which can in particular generate heat by means of a current supply by an electric current.

In particular, the fastening rail extends along the longitudinal direction over the entire length of the wiper blade. Alternatively, the fastening rail can preferably extend along the longitudinal direction over only part of the length of the wiper blade.

In particular, the heating element extends over the entire length of the wiper blade or, alternatively, it preferably extends over part of the length of the wiper blade.

In other words, a wiper blade is provided which comprises a fastening rail as an integral component in a base body. This fastening rail comprises a fastening groove, in which the heating element can be fastened. The fastening rail is designed such that the fastening arms of the fastening rail hold the heating element in place along the opening direction in which the fastening groove is open. The wiper blade offers the advantage of a particularly simple and cost-effective design. The separate components (base body and heating element) can be connected to each other without additional components. As a result, the entire wiper blade is able to be manufactured with a particularly simple, cost-effective and lightweight design.

Preferably, the fastening arms of the fastening rail are designed to exert a clamping force on the heating element when the heating element is in the fastened state in the fastening groove. In other words, the retaining element is in frictional contact with the fastening rail by means of the fastening arms. For example, the retaining element can be clamped between the two opposing fastening arms by means of the clamping force. As a result, the heating element can be fastened in a particularly easy and reliable manner, which enables rattle-free installation and also makes it possible to, e.g., compensate for tolerances.

The heating element also preferably comprises a support element and a heating wire. In other words, the heating element has a two-part design. The support element is designed in particular to retain the heating wire in position. Preferably, the support element is retained by means of the fastening arms. The heating wire can be designed to generate heat directly when supplied with an electric current. For example, the heating wire can be embedded in the support element or alternatively fastened to it. As a result, it is possible to provide a particularly simple, cost-effective, and flexible design for the heating element. The support element can, e.g., be used to position and retain the heating wire flexibly for optimum efficiency.

It is particularly preferable for the support element to comprise a support groove, in which the heating wire is fastened. Preferably, the heating wire is clamped into the support groove by means of a clamp connection. Therefore, particularly easy and cost-effective manufacturing and installation of the heating element can be enabled.

Preferably, the support element comprises (in particular, exactly two) opposing support grooves which are open in opposite directions. The heating wire is arranged inside the support grooves and extends around the circumference of the support element. Preferably, the support element can be essentially rod-shaped, wherein the support grooves are open to the outside on opposite longitudinal sides facing away from each other. In particular, the heating wire can be wound around the outer circumference of the support element inside the support grooves, e.g. exactly once. In other words, the heating element can be manufactured simply and cost-effectively, enabling simple and reliable installation and retaining of the heating wire for efficient heating.

Preferably, the heating element features a flat bar-shaped geometry. In particular, the retaining element in this case features an oval cross-section, preferably in a plane orthogonal to the longitudinal direction. A flat bar-shaped geometry is in particular considered to be a geometry which extends longitudinally along the longitudinal direction and has a thickness in a plane orthogonal to the longitudinal direction and a width orthogonal thereto, wherein the width is a multiple of the thickness. As a result, heat is able to be introduced into the wiper blade over a large area with small dimensions in the thickness direction. Therefore, a particularly effective heating of the wiper blade with a compact geometry can be performed.

Further preferably, the heating element is at least partially made of an electrically conductive material with an electrical resistance that has a positive temperature coefficient. In particular, the heating element is thus made of a material that features a PTC effect (PTC: Positive Temperature Coefficient). In other words, a heating element is provided that enables a heating function by means of a temperature increase resulting from a current supply to the heating element due to the PTC effect. Due to the predetermined temperature-dependent electrical resistance of the heating element, the current flow through the heating element leads to heat loss in the heating element and thus to heating of the heating element. In particular, due to the positive temperature coefficient of the heating element, the electrical resistance of the heating element increases significantly as the temperature rises. Due to the PTC effect, the heating element offers self- regulation of the heating function because the electrical resistance increases due to the rising temperature until the current flow through the heating element can no longer overcome the electrical resistance, or until the current flow becomes very low. In other words, the heating element inherently limits the maximum temperature to which it can be heated. In other words, the heating function can be provided in a particularly simple and reliable way.

Preferably, the fastening arms are designed to be elastically resilient, in particular such that the heating element can be removed from the fastening groove essentially along the opening direction and inserted into the fastening groove by elastically deforming the fastening arms. In particular, an undercut is thereby provided with respect to the opening direction of the retaining element and the fastening arms when arranged in the fastening groove. In particular, the heating element is held in place by means of the fastening arms, thus similar to a clip connection. Installation and removal are thus particularly easy given a reliable support means.

Preferably, the base body is designed as a single component that is integral together with the fastening rail and the fastening arm. For example, the base body can be designed as an injection component. Therefore, a particularly simple, cost-effective, and lightweight design and manufacture can be enabled.

Further preferably, the base body comprises a backbone region having at least one backbone element along the opening direction adjacent to the fastening rail. The backbone element is preferably designed to stiffen and/or shape the wiper blade. In particular, the backbone element enables the wiper blade to be pretensioned such that it can follow the surface of a curved windshield. The backbone element is preferably designed as a flat bar that extends along the longitudinal direction of the wiper blade. Preferably, exactly two parallel backbone elements are provided.

Particularly preferably, the wiper blade also comprises a wiper lip that extends along the longitudinal direction. The wiper lip is intended in particular to rest on a windshield. The wiper lip is preferably made of an elastic material, e.g. rubber.

The wiper blade preferably further comprises at least one fluid channel, which is formed within the base body and used for supplying fluid to a windshield washer device. In particular, the fluid channel extends along the longitudinal direction. Preferably, the windshield washer device can comprise at least one washer nozzle on the wiper blade. In particular, the fluid channel is arranged adjacent to the fastening groove. Preferably, exactly two fluid channels can be provided, wherein the fastening groove is arranged between the two fluid channels.

The invention further leads to a windshield wiper arrangement comprising a wiper arm and the wiper blade described. The wiper blade is fastened to the wiper arm, in particular by means of a connecting region, which is arranged in the middle of the wiper blade along the longitudinal direction.

Preferably, the windshield wiper arrangement further comprises a windshield washer device, which comprises at least one washer nozzle arranged on the wiper blade. In particular, the washer nozzle is supplied with fluid via at least one fluid channel inside the base body of the wiper blade.

### BRIEF DESCRIPTION OF THE DRAWINGS

The invention is described hereinafter based on exemplary embodiments in connection with the drawings. In the drawings, functionally identical components are respectively denoted by identical reference signs. Shown are:

FIG. 1 a simplified perspective view of a windshield wiper arrangement with a wiper blade according to a first exemplary embodiment of the invention,

FIG. 2 a detailed sectional view of the wiper blade in FIG. 1,

FIG. 3 a perspective view of a detail of the wiper blade in FIG. 1,

FIG. 4 a perspective view of a further detail of the wiper blade in FIG. 1, and

FIG. 5 a detailed sectional view of a wiper blade according to a second exemplary embodiment of the invention.

### DETAILED DESCRIPTION

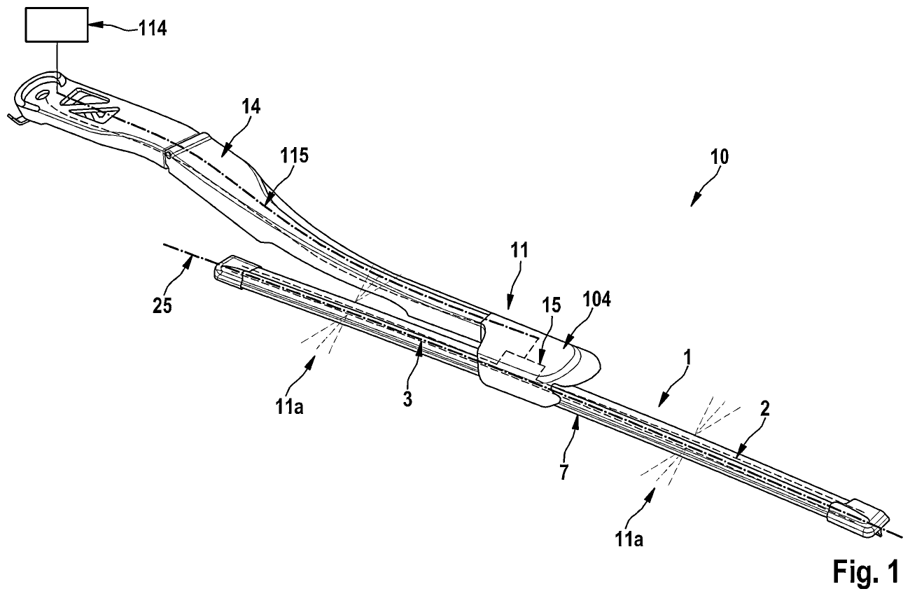

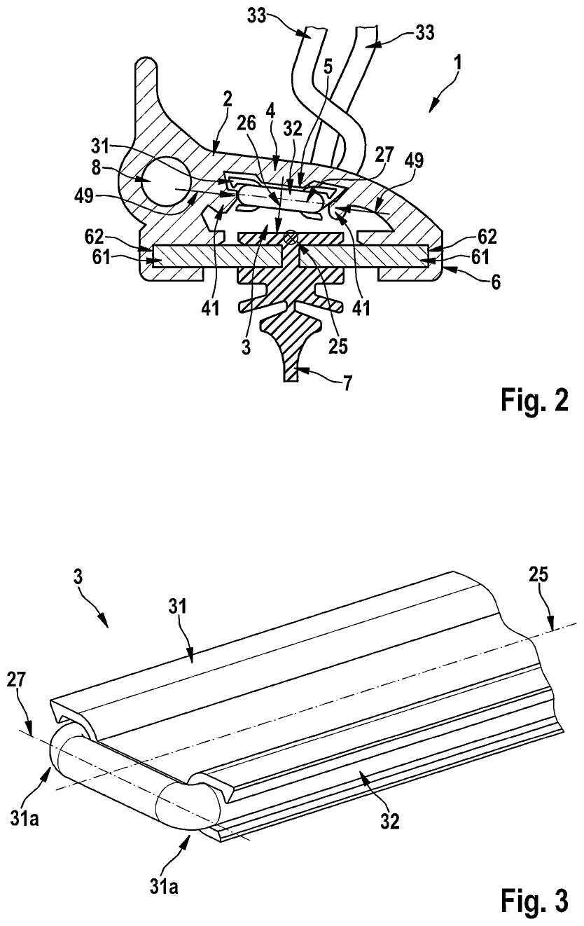

FIG. 1 shows a simplified perspective view of a windshield wiper arrangement 10 with a wiper blade 1 according to a first exemplary embodiment of the invention. A sectional view of the wiper blade 1 is shown in FIG. 2.

The windshield wiper arrangement 10 comprises a wiper arm 14, to which the wiper blade 1 is movably fastened at a connecting region 104. The connecting region 104 is located at a central region 15 of the wiper blade 1.

The wiper blade 1 comprises a base body 2, which extends along a longitudinal direction 25.

In addition, the wiper blade 1 comprises a wiper lip 7, which is preferably designed as a rubber lip and which is intended for wiping a windshield of a vehicle, e.g. a passenger car.

The windshield wiper arrangement 1 further comprises a windshield washer device 11, by means of which a windshield washer fluid can be applied to the windshield of the vehicle. For example, water can be applied to the windshield of the vehicle as a windshield washer fluid.

The windshield washer device 11 can comprise multiple nozzles 11a, which are configured to apply the windshield washer fluid to the windshield, e.g. in the form of a spray. The nozzles 11a can in this case be integrated into the wiper blade 1 and arranged in a distributed manner along the length of the wiper blade 1. In addition, the nozzles 11a are preferably oriented so that they can apply the windshield washer fluid to the windshield on one side of the wiper blade 1 at a time. As a result, windshield washer fluid is applied to the windshield in front of the wiper lip 7 in both directions in which the wiper blade 1 can move, thus enabling efficient cleaning of the windshield.

The windshield washer fluid can be supplied to the nozzles 11a via a fluid line that extends, e.g., along the wiper arm 14. The fluid line can be in fluid connection with a fluid channel 8, which is formed in the base body 2 of the wiper blade 1 (see FIG. 2). The windshield washer fluid can be fed to the nozzles 11a via the fluid channel 8.

The wiper blade 1 further comprises a backbone region 6 having two backbone elements 61, which are provided for stiffening and shaping the wiper blade 1 (see FIG. 2). For example, the backbone elements 61 can be preformed or pretensioned in a curved shape in order to, e.g., give the wiper blade 1 a shape adapted to a curved windshield.

The backbone elements 61 are designed as flat bars with a rectangular cross-section (see FIG. 2) and extend parallel to each other and parallel to the longitudinal direction 25

The backbone elements 61 are made of metal, preferably steel.

The backbone elements 61 are integrated into the base body 2 of the wiper blade 1. In particular, the backbone elements 61 are retained in grooves 62 of the base body 2.

The wiper lip 7 can, for example, be designed and arranged such that the sealing lip 7 is retained by the backbone elements 61 and between the backbone elements 61.

The wiper blade 1 further comprises a heating element 3, which is configured to heat the wiper blade 1. Icing can be prevented or dissipated by means of heating. In addition, heating can prevent the windshield washer fluid from freezing in the fluid channel 8. In addition, the wiper lip 7 can be heated as a result, which can achieve particularly effective wiping performance, in particular reduced noise during wiping and optimum cleaning performance.

To retain and position the heating element 3, the wiper blade 1 comprises a fastening rail 4, which is formed in the base body 2. The fastening rail 4 comprises a fastening groove 5, in which the heating element 3 is fastened.

FIG. 2 shows the cross-section of the wiper blade 1, wherein the geometry of the base body 2 comprising the fastening rail 4 and the fastening groove 5 is shown. The base body 2 preferably features, in particular essentially, the same cross-section along its entire length. This means, in particular, that the fastening rail 4 with the fastening groove 5 extends along the entire length of the base body 2.

The fastening groove 5 is open on one side in an opening direction 26 orthogonal to the longitudinal direction 25, which points in the direction of backbone elements 61 and wiper lip 7. The fastening groove 5 is closed on the side facing away from the wiper lip 7.

The fastening rail 4 comprises a fastening arm 41 on both sides of the fastening groove 5. In particular, the two fastening arms 41 also extend over the entire length of the base body 2. The fastening arms 41 thereby retain the heating element 3 in the fastening groove 5.

The fastening arms 41 are designed to protrude into the fastening groove 5, in particular along a transverse direction 27 which is orthogonal to the opening direction 26.

The fastening arms 41 are in this case elastically deformable and, together with the heating element 3, are designed to exert a clamping force 49, in particular along the transverse direction 27, on the heating element 3 in order to retain the latter.

In the first exemplary embodiment, the heating element 3 is designed in two parts and comprises a support element 31 and a heating wire 32 (see FIGS. 2 and 3). The support element 31 features an essentially flat bar-shaped geometry, whereby an outwardly open support groove 31a is formed on each of the sides opposite in the transverse direction 27. \

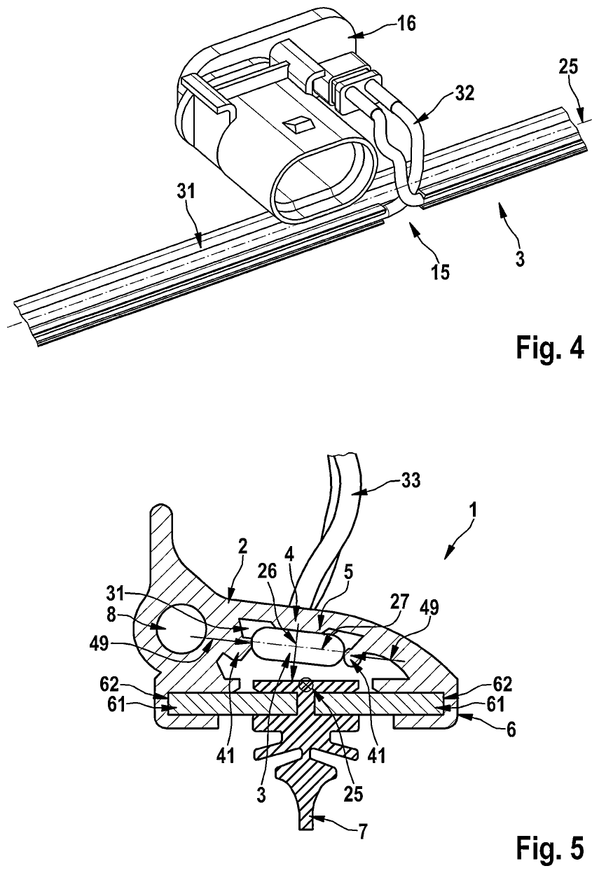

The heating wire 32 is fastened in the support grooves 31a, in particular by means of a clamp connection. In detail, the heating wire 32 is wound exactly once completely around the outer circumference of the support element 31 in a transverse plane in which the transverse direction 27 lies. The two ends of the heating wire 32 are connected to a plug 16 at the central region 15 (see FIG. 4).

The plug 16 can be electrically connected to a current supply device 114 via an electrical lead 115 extending along the wiper arm 14, and can be supplied with an electrical current by the current supply device 114 to enable heating of the wiper blade 1. The current supply device 114 can, for example, be arranged externally of the wiper arm 14 and wiper blade 1, e.g. on the vehicle.

The wiper blade 1 is characterized by a particularly advantageous design, which enables efficient heating by means of the heating element 3. The base body 2 is designed as a single component that is integral with the fastening rail 4, with the fastening groove 5, and with the fastening arms 31. A reliable and precise fastening and positioning of the heating element 3 can be provided for optimum function, while at the same time enabling a particularly simple and cost-effective design of the wiper blade 1 with few components. A particularly space efficient geometry of the wiper blade 1 can thereby be enabled.

FIG. 5 shows a detailed sectional view of a wiper blade 1 according to a second exemplary embodiment of the invention. The second exemplary embodiment essentially corresponds to the first exemplary embodiment in FIGS. 1 to 4, with the difference of an alternative design of the heating element 3. In the second exemplary embodiment shown in FIG. 2, the heating element 3 is designed as a single one-piece component featuring a flat bar-shaped geometry. In detail, the heating element 3 comprises an oval cross-sectional area in the cross-section orthogonal to the longitudinal direction 25. The heating element 3 is made of an electrically conductive material with an electrical resistance that features a positive temperature coefficient. In other words, the heating element 3 is made of a material that has a PTC effect (PTC: Positive Temperature Coefficient). Given current supply via supply wires 33, the PTC effect thus causes the heating element 3 to heat, thereby heating the wiper blade 1. In the second exemplary embodiment, the one-piece heating element 3 is clamped directly between the fastening arms 41.

1. A wiper blade for a windshield wiper arrangement (10), comprising:
a base body (2), which extends along a longitudinal direction (25),
a heating element (3), which is configured to heat the wiper blade (1),
wherein the base body (2) comprises a fastening rail (4) having a fastening groove (5), in which the heating element (3) can be fastened,
wherein the fastening groove (5) is open on one side in an opening direction (26) orthogonal to the longitudinal direction (25), and
wherein the fastening rail (4) comprises fastening arms (41) configured to retain the heating element (3) in the fastening groove (5).

2. The wiper blade according to claim 1, wherein the fastening arms (41) of the fastening rail (4) are configured to exert a clamping force (49) on the heating element (3) when fastened in the fastening groove (5).

3. The wiper blade according to claim 1, wherein the heating element (3) comprises a support element (31) and a heating wire (32).

4. The wiper blade according to claim 3, wherein the support element (31) comprises a support groove (31a), in which the heating wire (32) is fastened.

5. The wiper blade according to claim 4, wherein the support element (31) comprises opposing support grooves (31a) open in opposite directions, and wherein the heating wire (32) extends within the support grooves (31a) around a circumference of the support element (31).

6. The wiper blade according to claim 1, wherein the heating element (3) includes a flat bar-shaped geometry.

7. The wiper blade according to claim 1, wherein the heating element (3) is at least partially made of an electrically conductive material having an electrical resistance which has a positive temperature coefficient.

8. The wiper blade according to claim 1, wherein the fastening arms (41) are configured to be elastically resilient, so that the heating element (3) can be removed from the fastening groove (5) along the opening direction (26) by elastic deformation of the fastening arms (41) and can be inserted into the fastening groove (5).

9. The wiper blade according to claim 1, wherein the base body (2) is configured as a single component that is integral with the fastening rail (4) and the fastening arms (41).

10. The wiper blade according to claim 1, wherein the base body (2) comprises a backbone region (6) having at least one backbone element (61) along the opening direction (26) adjacent to the fastening rail (4).

11. The wiper blade according to claim 1, further comprising a wiper lip (7) extending along the longitudinal direction (26).

12. The wiper blade according to claim 1, further comprising at least one fluid channel (8) in the base body (2) for supplying fluid to a windshield washer device (11).

13. A windshield wiper arrangement comprising a wiper arm (14) and a wiper blade (1) according to claim 1, wherein the wiper blade (1) is fastened to the wiper arm (14).

14. The windshield wiper arrangement according to claim 13, further comprising a windshield washer device (11) having at least one washer nozzle (11a) arranged on the wiper blade (1).

15. The wiper blade according to claim 4, wherein the heating wire (32) is fastened in the support groove (31a) by a clamp connection.

16. The wiper blade according to claim 6, wherein the heating element (3) has an oval cross-section.

17. The wiper blade according to claim 2, wherein the heating element (3) includes a flat bar-shaped geometry.

18. The wiper blade according to claim 17, wherein the heating element (3) has an oval cross-section.
